(19) United States
(12) Patent Application Publication
(10) Pub. No.: US 2008/0196662 A1
(43) Pub. Date: Aug. 21, 2008

(54) Film guide for an embossing device

(75) Inventors: Guido Reschke, Hunfelden-Ohren (DE); Jurgen Scholzig, Mainz (DE); Uwe Puschel, Heidesheim (DE); Markus Jung-Diefenbach, Limburg (DE)

Correspondence Address: COHEN, PONTANI, LIEBERMAN & PAVANE LLP, 551 FIFTH AVENUE, SUITE 1210, NEW YORK, NY, 10176, US

(73) Assignee: MAN Roland Druckmaschinen AG, Offenbach am Main (DE)

(21) Appl. No.: 11/985,358

(22) Filed: Nov. 14, 2007

Related U.S. Application Data
(63) Continuation of application No. PCT/EP2006/000741, filed on Jan. 28, 2006.

(30) Foreign Application Priority Data
Feb. 4, 2005 (DE) 10 2005 005 492.7

(51) Int. Cl. B05C 13/00; B65H 57/00

(52) U.S. Cl. 118/500; 242/157 R

(57) ABSTRACT

A device for transferring an image-forming layer from a transfer film to a printing sheet, including an applicator unit for applying a coating of glue in the form of an image to the printing sheet; and a coating unit including an impression cylinder for guiding the printed sheet with the coating of glue facing away from the impression cylinder, and a pressure roller for guiding the transfer film with the image-forming layer facing away from the pressure roller. The impression cylinder and the pressure roller form a transfer gap therebetween so that the transfer film and the printing sheet are pressed against each other when guided through the transfer gap so that the image-forming layer remains adhered to the printing sheet in the area of the coating of glue and is lifted off from the transfer film after leaving the transfer gap. A process is also disclosed.

### CROSS-REFERENCE TO RELATED APPLICATIONS

This is a continuation of International Application No. PCT/EP2006/000741, filed on Jan. 28, 2006. Priority is claimed from German Patent Application No. 10 2005 005 492.7, filed on Feb. 4, 2005.

### BACKGROUND OF THE INVENTION

1. Field of the Invention

The invention relates to a device for transferring image-forming layers from a carrier film to printing sheets.

2. Description of the Related Art

It is known that metallic layers can be produced on printing sheets by means of a film transfer process. EP 0 569 520 B1, for example, describes a printing material and a printing device which uses this printing material. A sheet-fed press is shown, which has a feeder unit and a delivery unit, where the two printing couples and a coating unit are installed between the two units. In at least one of the printing couples, a glue pattern is applied by means of a flat printing method. This glue pattern is applied by a cold printing process and has a certain image-forming design. The coating unit, which follows the printing couple and which consists of an impression cylinder and a pressure roller, is provided with a film guide. The guide is intended to guide a strip of film or transfer film from a film supply roll through the transfer gap of the coating unit, i.e., the gap between the impression cylinder and the pressure roller. After leaving the coating unit, the film strip is wound back up again on the exit side. The transfer film has a carrier layer, to which the image-forming layers such as metallic layers of aluminum, for example, can be applied. Between the metallic layer and the carrier film, a separating layer is provided, which ensures that the metallic layer can be pulled off the carrier layer.

As the printing sheets are transported through the printing couple, the glue pattern is applied to each sheet. Then the sheet is guided through the coating unit, where, by means of the pressure roller, the sheet resting on the impression cylinder is brought into contact with the film material. The outward-facing metallic layer enters into intimate contact with the areas on the sheet carrying the glue. As the sheet continues to move onward, the metallic layer remains adherent only to the patterned areas of glue. In the area of the glue pattern, the metallic layer is therefore pulled away from the carrier film. The used transfer film is then wound back up again. The printing sheet is thus delivered in the coated state. It is known that these types of coating units can be used, for example, in the printing couples of printing presses. The known devices suffer from the disadvantage that they are not flexible enough in their application and that feeding the transfer film into the device is complicated and difficult.

### SUMMARY OF THE INVENTION

An object of the invention is therefore to provide a device by means of which the image-forming layer, e.g., a metallizing layer, can be transferred to a printing sheet reliably, economically, and precisely, and also which can be operated easily.

This object is accomplished by a device for transferring an image-forming layer from a transfer film to a printing sheet. The device includes an applicator unit configured to apply a coating of glue in the form of an image to the printing sheet; and a coating unit including an impression cylinder for guiding the printed sheet with the coating of glue facing away from the impression cylinder, and a pressure roller for guiding the transfer film with the image-forming layer facing away from the pressure roller. The impression cylinder and the pressure roller form a transfer gap therebetween so that the transfer film and the printing sheet are pressed against each other when guided through the transfer gap so that the image-forming layer remains adhered to the printing sheet in the area of the coating of glue and is lifted off from the transfer film after leaving the transfer gap. The device also includes a film guide device configured to guide the transfer film to the transfer gap. This object is also accomplished by a process for feeding a film web into a coating unit, the coating unit comprising a pressure roller and an impression cylinder, the pressure roller and the impression cylinder forming an open guide gap therebetween. The process includes the steps of taking a forward end of the film web from a film supply roll; connecting the forward end of the film web to a threading-in device or a transport device; feeding the threading-in device or the transport device into a film guide device; guiding the forward end of the film web through the film guide device by movement of the threading-in device or the transport device; guiding the forward end of the film web out of the coating unit and the guide gap; and guiding the forward end of the film web to a film take-up roll.

To guide the transfer film, it is advantageous to use a feed device, in which the transfer film is guided during the infeed operation to the transfer gap by a modular guide system.

It is advantageous for a device of this type for feeding the transfer film to have a guide device in the form of a cassette module, by means of which the infeed to the transfer gap and the removal from the transfer gap can be accomplished easily.

The device can also be used advantageously to improve the utilization of the film, in that the transfer film is divided into one or more partial film webs of reduced width. In combination with the previously mentioned process, therefore, it is also possible to use different types of film side by side.

To ensure the economy of the coating process, the film advance can be controlled in such a way that the transfer film is stopped whenever no image-forming or metallizing layer is to be transferred. It is advantageous for the transfer film to be controlled in such a way that the film advance is halted when the cylinder channel, which accommodates the grippers of the sheet-guiding impression cylinder, passes over the film. The pressure roller then slides past under the transfer film.

It is also advantageous to provide several coating units in a row within a sheet-fed press. Thus various image-forming layers or metallizing layers within one design can be applied in sequence. It is possible to transfer the image-forming layers side by side over a single glue pattern containing all of the image pattern elements. It is also possible to provide a first glue pattern in a first coating unit with a first image-forming coating or metallizing layer and then to superimpose an additional glue pattern surrounding the first one in a following unit and to provide that pattern with another image-forming coating or metallizing layer.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 shows a basic diagram of a printing press with a film transfer device;

FIG. 2 shows a device for guiding a transfer film on a pressure roller;

FIG. 3 shows a detailed diagram of a device for feeding transfer film; and

FIGS. 4 and 5 show detailed diagrams of variants of a device for guiding the transfer film away.

### DETAILED DESCRIPTION OF THE PRESENTLY PREFERRED EMBODIMENTS

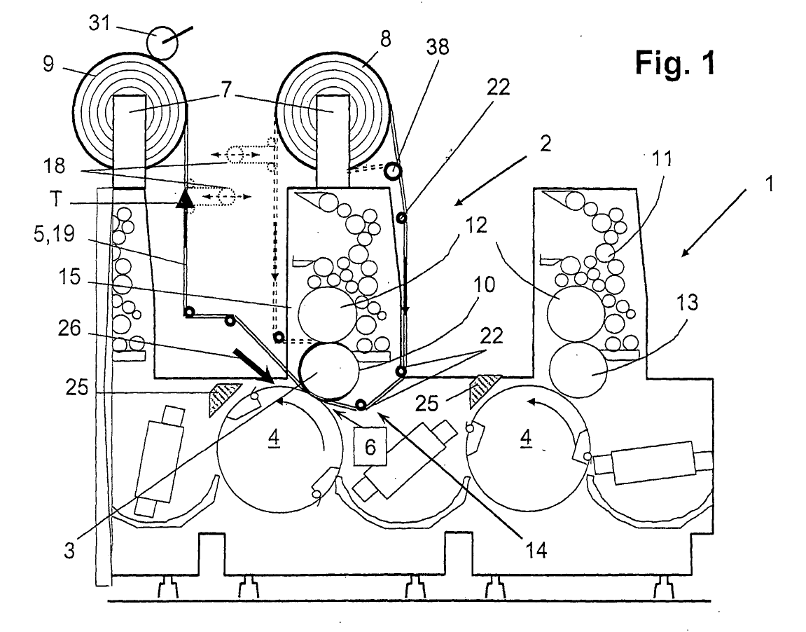

FIG. 1 shows a sheet-fed press, here a printing press, which consists of two printing couples. The two printing couples are used for the following purposes:

a sheet is first provided with an image-forming glue pattern (applicator 1 with an inking couple/dampening unit 11, a plate cylinder 12, and a blanket cylinder 13);

then in the following printing couple, a transfer film 5 is guided together with a printing sheet through a transfer gap 6, where the transfer film 5 is pressed against the sheet (coating unit 2 with pressure roller 3 and impression cylinder 4) in the transfer gap 6.

The transfer gap 6 in the coating unit 2 is formed by a pressure roller 3 and an impression cylinder 4. Here the pressure roller 3 can correspond to the blanket cylinder of an offset printing couple, and the impression cylinder 4 can correspond to the impression cylinder of such a couple. The pressure roller 3, furthermore, could also correspond to the form cylinder of a coating module of a sheet-fed printing press, and the impression cylinder 4 could correspond to the impression cylinder of that press.

Transfer films 5 have a carrier layer and a separating layer, to which the image-forming layer is applied. The separating layer makes it easier for the image-forming layer to be lifted off the carrier layer. The image-forming layer can be a metallized layer, a glazed layer, a texture layer, a colored layer, or a layer containing one or more image-forming patterns. The film supply roll 8 is assigned to the coating unit 2 on the same side as the sheet feeder. The film supply roll 8 has a rotary drive 7. The rotary drive 7 is needed to ensure the continuous, regulated infeed of transfer film 5 to the coating unit 2 and can therefore be controlled. In the area of the film feed, furthermore, there is a deflecting or tensioning roller. Thus the film web of the transfer film 5 is always held with the same tension against the pressure roller 3. On the delivery side of the coating unit 2, a film take-up roll 9 is installed, onto which the used-up film material is wound back up. For optimized production, a controllable rotary drive 7 should be provided here, too. The transfer film 5 could also be pulled by the rotary drive 7 on the delivery side and stopped on the feed side by a brake.

For the process of transferring the image-forming, e.g., metallized, layer to the substrate in the transfer gap 6, it is essential that the surface of the pressure roller 3 be equipped with a compressible damping element. The pressure roller 3 can for this purpose be provided with a pressing skin 10, consisting of a plastic covering, for example, comparable to a blanket. The pressing skin 10 is held by tensioning devices in a cylinder channel. The pressing skin 10 is provided with a specific elasticity or compressibility designed to improve the transfer properties in the transfer gap 6, this elasticity or compressibility being produced by means of conventional blankets or combination coverings consisting of blankets and underpackings.

One or more pressure surfaces limited to subject areas can also be provided directly on the pressure roller 3 or on the pressing skin.

According to the invention, the pressure roller 3 can also be installed in a single coating module together with a processing unit. For this purpose, a printing couple (here, for example, the couple 1 in FIG. 1) can be used to apply the glue, and a separate pressure roller can be set up on the same impression cylinder 4 of this printing couple behind the printing gap where the glue was applied. Alternatively, an additional device for glue application can be installed on the impression cylinder 4 of a printing couple (here the coating unit 2 according to FIG. 1) upstream of the transfer gap 6. Both arrangements result in a compact design.

For the intermediate or subsequent treatment of the glue layer or of the transfer image applied to it, dryers 25 can be installed downstream from the applicator unit 1 or the coating unit 2. If UV glue is used, for example, then, of course, UV dryers will be provided.

To check the applied transfer image, a monitoring system 26 for sheet inspection can be provided downstream from the coating couple 2. The monitoring system 26 can identify not only errors in the transfer image but also defects in the cold film embossing process.

To ensure the economy of the coating process, the film advance of the transfer film 5 from the film supply roll 8 to the transfer gap 6 and from there to the film take-up roll 9 can be controlled in such a way that, insofar as possible, the transfer film 5 is stopped whenever there is to be no transfer of the image-forming layer.

For this purpose, the transfer film 5 can be controlled in such a way that the film advance is stopped when the cylinder channel holding the grippers of the sheet-guiding impression cylinder 4 passes over the film. The pressure roller 3 also has a cylinder channel. No pressure is exerted on the transfer film 5 in the area of the correlating cylinder channels, which means that the pressure roller 3 can simply slide under the transfer film 5 while the transfer film 5 is being held between the pressure roller 3 and the impression cylinder 4. At the so-called lead edge of print, the transfer film 5 becomes clamped again together with a printing sheet between the pressure roller 3 and the impression cylinder 4 and thus transported further along. The clock speed of the film advance can be adjusted in correspondence with the necessary acceleration or deceleration of the film supply roll 8 or film take-up roll 9 by way of so-called dancing rollers 18 or by means of the rotary drives 7 of the film rolls 8, 9.

The utilization of the film can also be improved in the manner described when the transfer film 5 is divided into one or more partial film webs of reduced width. With appropriate control by means of the device or devices for timing the film advance of each of the partial film webs, the utilization of the transfer film 5 can be improved even when the areas to be coated within a sheet have zones of different length. For this purpose, each partial film web is advanced only in the area where the image-forming surface layer is to be applied. In the areas not to be coated, each partial film web can be held still independently of the other partial film webs, and therefore there is no unnecessary consumption of film.

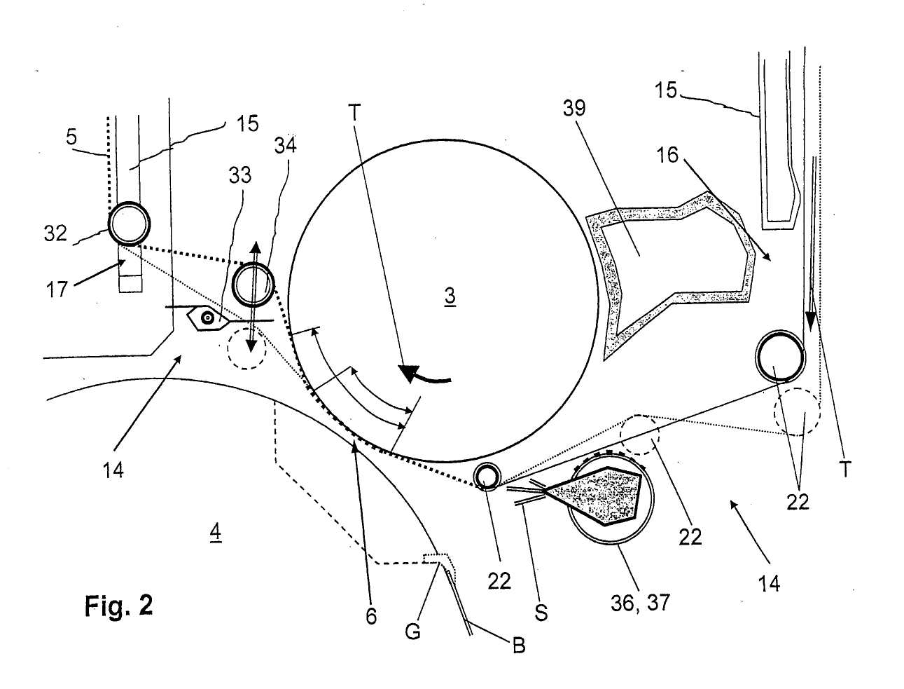

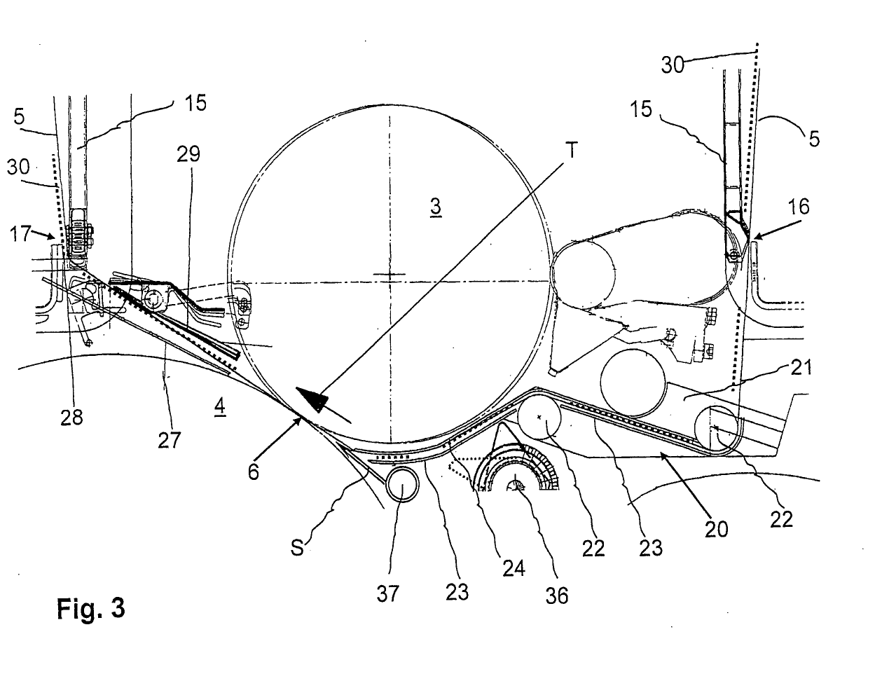

According to the invention, a device for guiding film is provided on the pressure roller 3 as shown in FIG. 2. The film is guided essentially at a tangent to the pressure roller 3 through the transfer gap 6 between it and the impression cylinder 4 of the coating unit 2. The guide comprises a corresponding film guide device 20 (see FIG. 3) and a film feed device 30 (see FIG. 3), which are described farther below, and which guide the film web 5 in the transport direction T (see FIG. 3) through the coating unit 3.

What is provided is a film guide 14 (see FIG. 2), which is oriented more-or-less at a tangent between the pressure roller 3 and the impression cylinder 4, and which forms a loop of less than 90° around the pressure roller 3. This ensures the defined contact and guidance of the film web 5 by the pressure roller 3 and simultaneously creates the necessary conditions for a possible film-advance timing, i.e., for stopping the film in the transfer gap 6 as the channel passes through the transfer gap 6, and also the conditions for the use of narrow film webs 5.

On the infeed side of the transfer gap 6, starting from the infeed opening 16 of a printing couple guard 15, the film guide 14 for a film web 5 or for partial film webs 19 comprises several guide rollers 22. Depending on the configuration of the printing couple, these rollers can be arranged in different ways. According to FIG. 2, the film guide 14 can be arranged in conjunction with an impression cylinder blowdown device 36. This device has blast openings to form blast jets S, which are used to guide a substrate B on the impression cylinder 4 as it enters the transfer gap 6. The impression cylinder blowdown device 36 can also be directed onto the film web 5 for pneumatic support to keep the web taut and spread out, free of wrinkles. If the impression cylinder blowdown device 36 is arranged appropriately, it can be possible under certain conditions to eliminate one of the guide rollers 22 which guides the film web 5.

A mechanical or pneumatic guide element on the edge of the printing couple guard 15 in the area of the entrance opening 16 can also be part of the film guide 14; this element holds the film web 5 taut and flat as it enters the coating unit 2.

The film guide 14 also guides the film web 5 past a cleaning device 39, which cooperates with the pressure roller 3. The cleaning device 39 is designed to remove residues of film or film processing-related dirt from the pressure roller 3.

Another part of the film guide 14 comprises guide rollers 32, 34 on the delivery side, between from the transfer gap 6 and an outlet opening 17 in a printing couple guard 15. These rollers 32, 34 can again be arranged in different ways depending on the configuration of the printing couple. The film guide 14 here is arranged in conjunction with an intake guard 33. This serves to protect the transfer gap 6 from unintended intrusions. The film web 5 can be guided around the intake guard 33 or through openings in its contour. The guide rollers 32, 34 can be arranged in conjunction with the printing couple guard 15, so that they carry the film web 5 along with them when the guard is moved. Alternatively, the guide roller 34 can be installed so that its position can be adjusted to increase or decrease the angle of wrap of the film web 5 on the pressure roller 3.

In this context it is also significant that the transfer film 5 can come in contact with the grippers G on the impression cylinder 4 as the channel passes through the transfer gap G. The grippers G firmly hold a printing sheet B by its leading edge on the impression cylinder 3, so that it can be transported securely through the transfer gap 6. The so-called “backs” of the grippers project slightly above the circumference of the impression cylinder 4 in the area where they clamp the leading edge of the printing sheet B. The coordination with the channel of the impression cylinder also present in the pressure roller 3 is selected so that the edge of the channel of the pressure roller 3 does not come in contact with the impression cylinder 4 until after the contour of the grippers G has passed by. Because the film web 5, however, extends freely over the channel in the pressure roller 3 and thus has no support in this area, the grippers G cannot dig themselves into the film web 5 here. It is also advantageous for the angle of wrap of the film web to be adjustable, so that the grippers G can be separated quickly from the film web 5 on passage of the channel through the transfer gap 6.

The grippers G are preferably designed with a contour which projects to the least possible extent above the circumference of the impression cylinder 4. Systems of grippers G can also be used, all of which are adjustable in the radial direction with respect to the impression cylinder 4, either permanently or in cycles, so that the height of the grippers G above the cylinder contour can be minimized.

The task of the film guide 14 can also be assisted by providing the cylinder channel in the pressure roller 3 with a cover, which more-or-less completes the cylindrical surface of the pressure roller. It is true that, as a result, the film web 5 will be brought closer to the impression cylinder 4 in the area of the grippers G, but overall the film is guided more continuously and more smoothly.

The guidance of the transfer film 5 can also be influenced by an additional guide roller 38 (see FIG. 1), located just after the point where the film leaves the film supply roll 8. By means of this guide roller 38, the axis of which can be adjusted with respect to the position of the axis of the film supply roll 8, irregularities or nonuniformities in the process of taking the film off the supply roll 8 can be corrected before the film web 5 is fed into the film guide 14.

According to FIG. 3, a slide-in cassette 21 is provided with guide elements of metal and/or plastic (CFP) (i.e., carbon fiber-reinforced plastic). Rotating guide rollers 22 are provided as guide elements. Air-swept blast rods or blast rods of sintered metal from which the air is directed toward the film web 5 can also be used, so that the transfer film 5 is carried on a cushion of air. The guide rollers 22 can be made of aluminum or reinforced plastic, e.g., CFP, so that they are light-weight and thus exert the least possible stress on the film web 5. The guide rollers 22 can be surface-coated, e.g., with Teflon or some other material, to decrease the adhesion of the transfer film 5. Guide plates 23, which are assigned to the guide rollers 22 and which can be coated in the same way, help to keep the film web 5 straight and level. The guide plates 23 are preferably arranged to form a guide channel 24, which serves both to guide (and to deflect) the film as it travels and also to facilitate the insertion of the film as it is being threaded in at the beginning of a production process.

A separate impression cylinder blast device can be assigned to cooperate with the slide-in cassette 21, or the slide-in cassette 21 can be configured as a single structural unit together with the impression cylinder blast device. In the latter case, the slide-in cassette 21 can be used simultaneously to guide the printing sheet on the impression cylinder 4.

The film guide device 20 can also be assisted by a device for generating blast air. For this purpose, a blowdown device 37 can be installed at the point where the film exits the guide device and enters the transfer gap 6 between the pressure roller 3 and the impression cylinder 4. This blowdown device directs one or more bundled or fanned-out air jets S under the film web 5 and onto the substrate, e.g., label paper, which can be very thin, to guide the sheet. The blast air stream of the air jet S also carries and smoothes out the film web 5. It is possible here in particular to combine this device with an impression cylinder blowdown device.

If the blast air is conducted through the guide channel 24, it will cool the film guide device 20, i.e., its guide elements, so that frictional heat caused by the transport of the film can be carried away from the device.

The film guide device 20 can have easily replaceable guide elements, e.g., guide rollers 22 or guide plates 23, at the especially critical deflection or exit points, so that the service department can easily replace these wear parts.

A special guide for cardboard can be assigned to the film guide device 20 or integrated into it to form a single structural unit to prevent contact between the film web 5 and the substrate (cardboard) before the film enters the transfer gap 6 between the pressure roller 3 and the impression cylinder 4.

On the exit side, i.e., downstream in the transport direction of the film web 5 from the transfer gap 6 between the pressure roller 3 and the impression cylinder 4, a support plate 29, possibly subjected to blast air, is provided above the film web 5. Underneath the film web 5, a deflector 27 can be temporarily inserted to help with the threading-through of the film.

On the exit side, a film deflection unit is preferably integrated into an existing printing couple guard 15 of the coating unit 2, e.g., a guard for an automatic plate loading device. Here again the use of a guide roller 32 or of a coated guide plate 28 or of an air-swept deflecting rod is also possible.

When a printing couple is being operated as a coating unit 2 with film webs 5, the previously mentioned printing couple guards 15 can be automatically moved into a defined, preselectable, and lockable open position, so that a properly dimensioned entrance opening 16 and exit opening 17 are created for the film web 5.

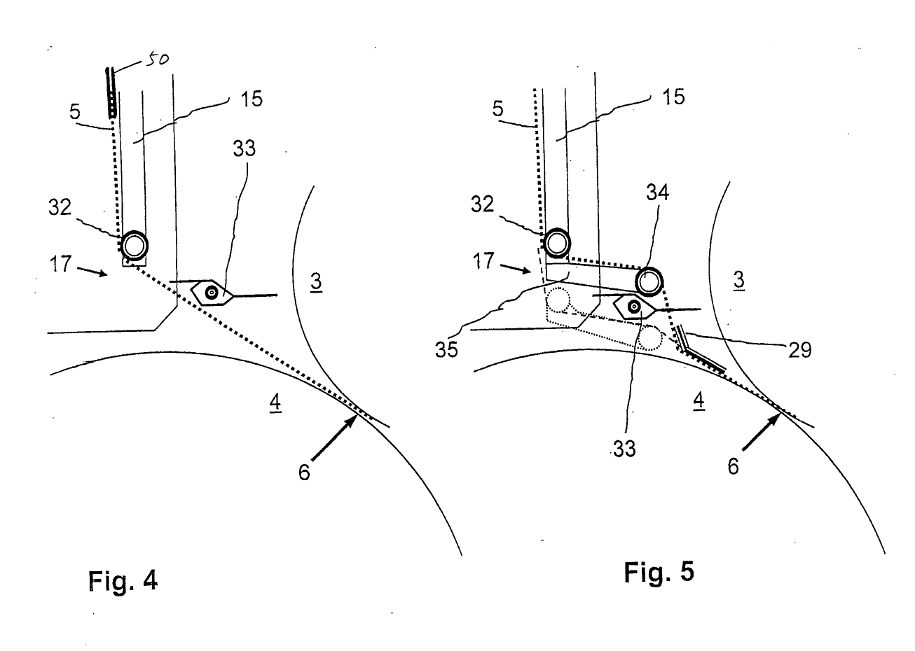

FIGS. 4 and 5 show variants of ways in which the film web 5 can be guided out of the coating module 2.

In FIG. 4, a guide roller 32 is let into the bottom edge of the printing couple guard 15. The film web 5 can now be guided in a straight line from the transfer gap 6 to the guide roller 32 and thus carried out through the exit opening 17. This arrangement is a simple way to guide the film web 5, and only slight modifications to the printing couple guard 15 are required.

Alternatively, a pair of guide rollers 32, 34 can be provided as shown in FIG. 5. These guide rollers 32, 34 can be arranged on a bracket 35 mounted on the printing couple guard 15 or on a bracket which is independent of the printing couple guard 15. The bracket 35 can accordingly be installed in and positioned on the coating module 2 or on the printing couple guard 15, or it can have its own independent means of adjustment. To improve access to the impression cylinder 4, the bracket 35 can be arranged in such a way that it is positioned above an intake guard 33.

The intake guard 33 serves to protect the transfer gap 6 from unintended intrusions. In this case, the intake guard 33 is provided with a through-opening for the film web 5. In addition, a support plate 29 to help guide the film web 5 away from the transfer gap 6 is again provided. Thus the film web 5 can be guided out of the transfer gap 6, over the support plate 29, over the guide roller 34, then over the guide roller 32, and finally out through the exit opening 17.

Alternatively, as illustrated in broken line, the bracket 35 can be mounted together with the guide rollers 32, 34 underneath the intake guard 33. In this case, the film web 5, in the absence of the support plate 29, can travel in a straight line to the first guide roller 34 and over this to the second guide roller 32, so that it can be carried away through the exit opening.

The bracket 35 can also be designed so that the position of the guide roller 34 can be changed with respect to the position of the guide roller 32. This can be done manually. A servo drive can also be provided, by means of which the working position of the guide roller 34 can be adjusted as a function of an operating state or of appropriate technical parameters by the press control unit. According to another alternative, the intake guard 33 can be equipped to accept guide devices for the film web 5.

A guide belt or draw belt or strip of metal or plastic or foil or a pair of magnetic foils 50 (see FIG. 4) can be attached to the forward end of the film on the supply roll to help guide the film. This auxiliary device can be used to push or to pull the film web 5 through the film guide device 20 within the coating unit 2.

A partially or fully automated infeed device 30 in the form of a pull cable, a pull chain, or a belt can also be assigned to the coating unit 2. The infeed device 30 can be used for either the entire route of the film web 5 or only the area within the coating unit (printing couple of a sheet-fed offset printing press or coating module in a sheet-fed printing press). For example, a device in the form of a strip of spring steel can be pulled through the coating unit between the two sides of the press.

When the film is to be changed or has torn, the pressure roller 3 and the impression cylinder 4 are pulled back automatically into a retracted position, that is, preferably into a position in which the cylinder channels of the two cylinders 3, 4 are not in a synchronous position (i.e., not facing each other), because this is disadvantageous for the passage of the film. The lateral surfaces of the cylinders 3, 4 in the transfer gap 6 should instead serve as guide surfaces for the passage of the film. The cylinders 3, 4 are thus switched into a so-called “pressure-off” position, so that a setup program can be used to maintain an open guide gap for the passage of the film through the area of the transfer gap 6.

The film take-up roll 9 can be provided with a pinch roller 31 (see FIG. 1) to serve as a friction and guide roller with adjustable contact force and pretension. By means of this pinch roller 31, a defined tension (film tension) can be maintained on the film take-up roll 9, so that the film web 5 will run sideways to only a very limited extent and the problems which this might cause are avoided. In addition, flanged wheels or suitable guide surfaces can be provided at the edges of the film web 5 to prevent the film from traveling laterally from the core of the coil and thus to ensure that the film is wound up straight on the film take-up roll 9.

By means of the film guide 14, 20 described above, it becomes possible both to thread the film into a coating unit 2 and to guide it within the unit. Ease of operation is ensured at all times, and the setup times are minimized. Finally, the film guide 14, 20 makes possible a high degree of automation of all the tasks and settings involved in threading in the film and guiding it through the press.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A device for transferring an image-forming layer from a transfer film to a printing sheet, the device comprising:
an applicator unit configured to apply a coating of glue in the form of an image to the printing sheet;
a coating unit comprising:
an impression cylinder for guiding the printed sheet with the coating of glue facing away from the impression cylinder; and
a pressure roller for guiding the transfer film with the image-forming layer facing away from the pressure roller,
wherein the impression cylinder and the pressure roller form a transfer gap therebetween so that the transfer film and the printing sheet are pressed against each other when guided through the transfer gap so that the image-forming layer remains adhered to the printing sheet in the area of the coating of glue and is lifted off from the transfer film after leaving the transfer gap; and
a film guide device configured to guide the transfer film to the transfer gap.

2. The device of claim 1, wherein the film guide device has a guide channel for guiding the transfer film to the transfer gap.

3. The device of claim 1, wherein the film guide device comprises at least one film guide element for guiding the transfer film away from the transfer gap.

4. The device of claim 3, wherein the at least one film guide element forms a single structural unit removably or adjustably installed in the coating unit or on a printing couple guard.

5. The device of claim 1, wherein the film guide device is configured as a single structural unit in the form of a slide-in cassette which is removably, adjustably, or fixedly installed in the coating unit.

6. The device of claim 5, further comprising a substrate guide device assigned to a surface of the impression cylinder, the film guide device and the substrate guide device forming a structural unit.

7. The device of claim 6, wherein the substrate guide device comprises an impression cylinder blowdown device configured to generate blast air directed at the surface of the impression cylinder.

8. The device of claim 6, wherein the substrate guide comprises a blowdown device configured to generate blast air under the transfer film and directed at a substrate guided on the surface of the impression cylinder.

9. The device of claim 6, wherein the film guide device has a guide channel for guiding the transfer film to the transfer gap, the substrate guide device comprising a blowdown device configured to generate blast air directed into the guide channel and under the transfer film, the guide channel being oriented so that the blast air coming out of the guide channel is directed at a substrate guided on the surface of the impression cylinder.

10. The device of claim 6, further comprising a separating guide for separating the transfer film from a cardboard on the surface of the impression cylinder before the transfer film enters the transfer gap, the film guide device and the separating guide forming a structural unit.

11. The device of claim 1, wherein the transfer film comprises a plurality of partial film webs with a reduced width, the film guide device being configured to feed the plurality of partial film webs side by side to the transfer gap.

12. The device of claim 11, wherein the film guide device comprises guide elements for guiding the plurality of partial film webs side by side to the transfer gap.

13. The device of claim 3, wherein the at least one film guide element is configured so that an angle of wrap of the transfer film on the pressure roller is adjustable.

14. The device of claim 13, wherein a position of one guide element of the at least one film guide element is adjustable with respect to the transfer gap.

15. The device of claim 13, wherein the at least one film guide element comprises a guide roller arranged at an adjustable position with respect to the transfer gap, or a pair of guide rollers, each of which is arranged at an adjustable position with respect to the transfer gap.

16. A device for transferring an image-forming layer from a transfer film to a printing sheet, the device comprising:
an applicator unit configured to apply a coating of glue in the form of an image to the printing sheet;
a coating unit comprising:
an impression cylinder for guiding the printed sheet with the coating of glue facing away from the impression cylinder; and
a pressure roller for guiding the transfer film with the image-forming layer facing away from the pressure roller,
wherein the impression cylinder and the pressure roller form a transfer gap therebetween so that the transfer film and the printing sheet are pressed against each other when guided through the transfer gap so that the image-forming layer remains adhered to the printing sheet in the area of the coating of glue and is lifted off from the transfer film after leaving the transfer gap; and
a transport device for pulling in a forward end of the transfer film along a guide path into the transfer gap and then out of the transfer gap.

17. The device of claim 16, further comprising a connector connecting the forward end of the transfer film to the transport device, the connector being detachably connected to the forward end of the transfer film.

18. The device of claim 17, wherein the connector comprises two magnetic foil layers sandwiching the forward end of the transfer film therebetween.

19. A process for feeding a film web into a coating unit, the coating unit comprising a pressure roller and an impression cylinder, the pressure roller and the impression cylinder forming an open guide gap therebetween, the process comprising the steps of:
taking a forward end of the film web from a film supply roll;
connecting the forward end of the film web to a threading-in device or a transport device;
feeding the threading-in device or the transport device into a film guide device;
guiding the forward end of the film web through the film guide device and the guide gap by movement of the threading-in device or the transport device;
guiding the forward end of the film web out of the coating unit after exiting the guide gap; and
guiding the forward end of the film web to a film take-up roll.
